(19) United States
(12) Patent Application Publication
(10) Pub. No.: US 2012/0262557 A1
(43) Pub. Date: Oct. 18, 2012

(54) PHOTOGRAPHING AND AUDIO/VIDEO RECORDING OF A PARTY WHILE BEING SERVED WITH LEGAL PAPERS

(76) Inventor: Steven Friedland, Miami, FL (US)

(21) Appl. No.: 13/365,809

(22) Filed: Feb. 3, 2012

Related U.S. Application Data
(60) Provisional application No. 61/439,575, filed on Feb. 4, 2011.

(51) Int. Cl. H04N 7/18

(52) U.S. Cl. 348/61; 348/E07.085

(57) ABSTRACT

A method and various apparatus are disclosed relating to employing audio/visual recording equipment to make a record of the act of serving official papers on an individual. The act of recording may be concealed and the recorded content may be used commercially or for official purposes.

### CROSS REFERENCE TO RELATED APPLICATIONS

This utility patent application claims priority to a provision application entitled “Photographing And Audio/Video Recording Of A Party While Being Served With Legal Papers,” filed on Feb. 4, 2011 and having Application No. 61/439,575. The aforementioned application is also incorporated by reference herein.

### FIELD OF THE DISCLOSURE

The subject matter of the present disclosure relates to a method for recording a person while he or she is served with official documents such as legal papers, and the subsequent use of that recording.

### SUMMARY OF THE DISCLOSURE

A method is disclosed for capturing audio and/or video of a party being served legal papers. The system is capable of capturing audio, video, or a combination of both. In some embodiments, the system includes a microphone, camera, processor, and a storage unit. In some embodiments, the system can be discreetly housed in a number of accessories that would prevent the recording equipment from being visually detected by the subject of the recording. The video/audio recordings produced can be transmitted (simultaneously or otherwise) and/or uploaded to a website accessible to users via the internet where the recordings can be viewed and/or listened to. The website may profit from this content in any manner known, for example by using advertising, pay-to-access or pay per usage basis. Furthermore, the recording may be desired by parties involved in legal proceeding related to the service or other legal proceedings. Making the recording and providing associated access may be tailored geographically or otherwise in accordance with applicable state and Federal laws.

The recordings can also be burned to a CD/DVD/USB or other digital device for a fee which can then be used for identity verification purposes through the court system and be posted on a website for viewing and generating associated profit.

The foregoing summary is not intended to summarize every aspect of the present disclosure.

### BRIEF DESCRIPTION OF THE DRAWINGS

The foregoing summary and other aspects of subject matter of the present disclosure will be best understood with reference to a detailed description of the process, which follows, when read in conjunction with the accompanying drawings, in which:

FIG. 1 illustrates the method of recording a party while serving him/her with legal papers.

FIG. 2 illustrates the recording system according to certain teachings of the present disclosure

While the subject matter of the present disclosure is susceptible to various modifications and alternative forms, specific examples are herein described in detail. The figures and written description are not intended to limit the scope of the inventive concepts in any manner. Rather, the figures and written description are provided to illustrate the inventive concepts to a person skilled in the art by reference to particular embodiments, as required by 35 U.S.C. §112.

### DETAILED DESCRIPTION

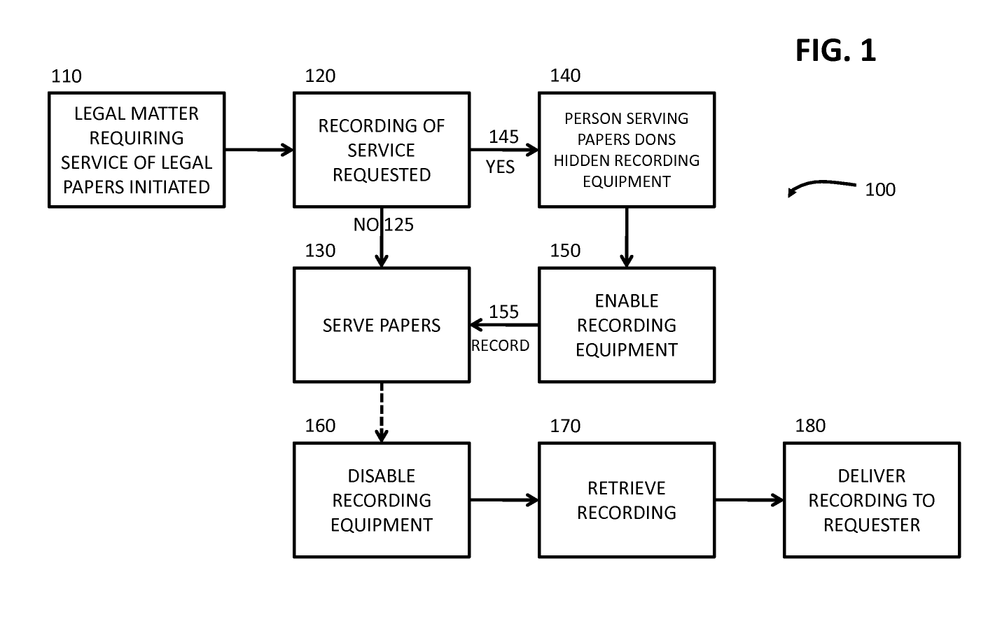

Referring to FIG. 1, a method 100 for recording a party while serving that party with legal papers. First, a legal (or other formal) matter may be initiated 110 that requires serving a party with legal or official documents. The party initiating service then decides whether or not they want to request 120 that the opposing party be recorded while being served with papers. If the initiating party does not choose 125 to record the opposing party while being served, the opposing party is served 130 the legal papers in the typical manner. If, however, the initiating party selects 145 to have the opposing party recorded while being served, the person who will serve the papers employs the recording equipment 140, which may or may not be hidden. The recording equipment can be hidden or disguised in any number of accessories to best coordinate with the clothing the person serving the papers is wearing. Examples of accessories that can be used to house the recording equipment include, but are not limited to a pair of sunglasses, a pen, A HAT, a brooch, or even a standard video/audio recording device in plain view. Prior to confronting the opposing party, the person wearing the recording equipment enables the recording equipment 150 to begin recording 155. The person wearing the recording equipment then serves opposing party 130 the legal papers as usual. The recording equipment is then disabled 160 after the papers have been served. The recording is retrieved 170 from a storage location and then delivered 180 to the initiating party that requested the recording and/or anyone provided such access is allowable under local or state law.

The method 100, illustrated in FIG. 1, includes other orders in which the steps are carried out. For example, the person serving the legal papers may enable the recording equipment before donning the device.

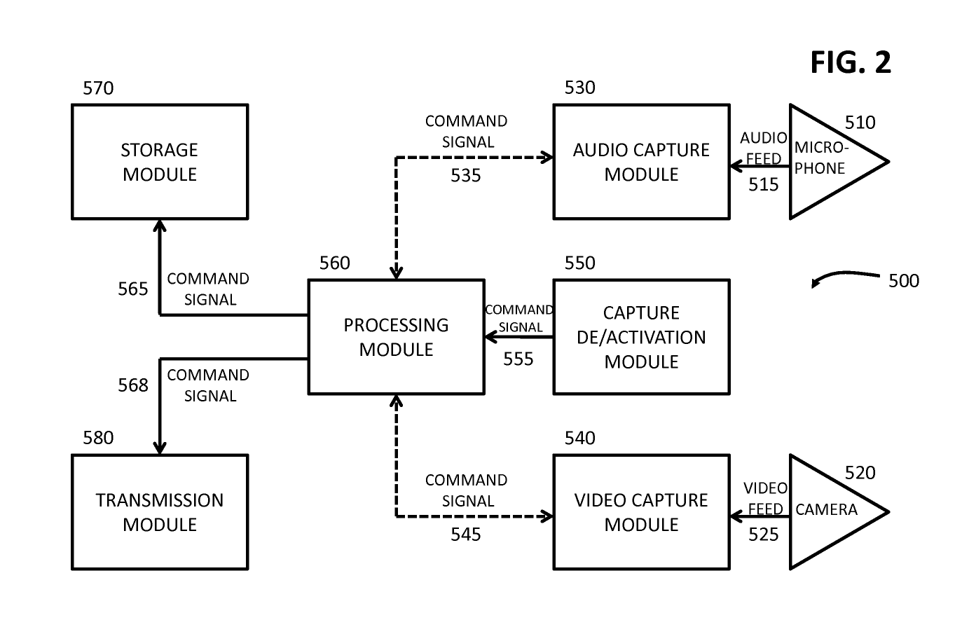

Referring to FIG. 2, the recording system 500 may be capable of recording audio, video, or both. The capture de/activation module 550 sends a command signal 555 to the processing module 560 to either start or stop recording. The processing module 560, in turn, sends independent command signals 535 and 545 to either or both the audio and video capture modules 530 and 540 to either start or stop recording. During operation, and upon a start recording command 535 and 545 from the processing module 560, the microphone 510 captures audio and provides an audio feed 515 to the audio capture module 530; and the camera 520 captures video and provides a video feed 525 to the video capture module 540. Both the captured audio 530 and 540 video are sent to the processing module 560. The processing module 560 then sends a command signal 565 to the storage module 570 to store the captured audio and video. Lastly, the stored audio and video data can be transmitted via the transmission module 580 upon a command signal 568 from the processing module 560.

The capture de/activation module 550 can send a command signal 555 to the processing module 560 through various methods. For example, the signal 555 can be sent wirelessly or by physical actuation of a button on the recording equipment.

Upon a command signal 565 from the processing module 560, the storage module 570 can store the data locally or remotely. Local storage would be contained with the recording equipment and hidden in the chosen accessory, e.g., chosen by the person serving the papers. Further, the data can be wirelessly transmitted to a remote storage location.

The recording can then be adapted to a website, DVD/CD/USB, and or other digital device and made available to the parties involved, the court system, and/or anyone legally allowed to gain access per local and/or state law.

Viewing/listening of the recordings may be commercialized in any known way, for example: pay per view on a website; pay for unlimited views on a single or group of videos, where the grouping may or may not be logical, such as all videos for one plaintiff, one defendant, one case, one district, etc.; use of advertising; sale or rental of CD, DVD or other digital form; assembly into a comedic or instructive audio/video show; or any other known commercialization of content.

1. A method comprising the steps of:
obtaining official documents;
receiving a request to photographically record service of the official documents upon an individual or entity;
employing a service person to visit the individual or a person representing the entity;
concealing upon the service person an audio/visual recording device;
enabling the recording device to begin making an audio and/or visual record;
during operation of the recording device and within the recording range of such device, serving the official papers upon the individual or person representing the entity; and
after serving the official papers, disabling the recording device such that it is no longer making a audio/visual record.

2. The method of claim 1 wherein the record is digital.

3. The method of claim 2 wherein the record is stored in a memory housed with the audio/visual recording device.

4. The method of claim 3 further comprising the step of wirelessly transmitting the stored record to a remote location.

5. The method of claim 3 further comprising the step of making the record available through the Internet.

6. The method of claim 5 further comprising the step of providing access to the record in exchange for compensation.

7. The method of claim 5 further comprising the step of monetizing the record's presence on the Internet through advertising.

8. A method comprising the steps of:
making a record of a person being served with official papers, wherein the record comprises at least digitized audio or video content;
transmitting the record to a remote storage;
adapting the record for use on a website;
making the adapted record available on a website; and
commercializing access to the video.

9. The method of claim 8 wherein the record is initially stored in a memory housed with an audio/visual recording device that is employed to make the recording.

10. The method of claim 8 wherein the record is transmitted to the remote storage wirelessly.
